(19) United States
(12) Patent Application Publication
(10) Pub. No.: US 2026/0266971 A1
(43) Pub. Date: Sep. 10, 2026

(54) DISTANCE MEASUREMENT SYSTEM

(71) Applicant: Hitachi High-Tech Corporation, Tokyo (JP)

(72) Inventors: Kenji MARUNO, Tokyo (JP); Tatsuo HARIYAMA, Tokyo (JP); Masahiro WATANABE, Tokyo (JP); Hidehiko KANDO, Tokyo (JP); Hirohito AKIYAMA, Tokyo (JP)

(21) Appl. No.: 19/118,184

(22) PCT Filed: Oct. 10, 2023
(86) PCT No.: PCT/JP2023/036760

§ 371 Date: Apr. 3, 2025

(30) Foreign Application Priority Data
Nov. 11, 2022 (JP) 2022-180861

(51) Int. Cl. G01S 7/497; G01S 7/481; G01S 7/4911; G01S 7/51; G01S 17/34; G01S 17/36

(52) U.S. Cl. CPC G01S 7/497; G01S 7/4814; G01S 7/4911; G01S 7/51; G01S 17/34; G01S 17/36

(57) ABSTRACT

A distance measurement system evaluates whether a frequency sweep state of a light source is normal and includes: a light source that outputs FM light; a measurement optical system that splits one beam of the FM light into two beams, one beam of which is then split into two beams and outputs a measurement beat signal; and a reference optical system that splits the other beam of the two beams of FM light into two beams and outputs a reference beat signal. A calculation device performs processing on the measurement beat signal and the reference beat signal to calculate a distance to a measurement object based on the measurement beat signal. A beat signal processing unit processes the reference beat signal to generate a desired signal, and a determination of an abnormality of the light source is made by comparing the desired signal with a reference value.

### TECHNICAL FIELD

The present invention relates to a distance measurement system that measures a distance to a measurement object in a non-contact manner.

### BACKGROUND ART

As a method of measuring a distance to a measurement object in a non-contact manner, a frequency modulated continuous waves (FMCW) method is known in which a distance to a measurement object is indirectly measured by irradiating the measurement object with FM light whose frequency is swept and analyzing an interference beat signal generated by interference between the irradiation light and reflected light. As an example of a distance measurement system using the FMCW method, there is a technique described in PTL 1.

For example, in paragraphs [0034], [0035], and of PTL 1, the following is disclosed. “FIG. 2 is a diagram illustrating the principle of the FMCW method” “AS illustrated in FIG. 2, there is a time difference Δt between a timing at which reference light 201 arrives at a light receiver 107 and a timing at which measurement light 202 arrives at a light receiver 109. In the time difference Δt, since an optical frequency of FM light from a laser light source 101 changes, a distance measurement unit 116 detects a target measurement beat signal having a beat frequency fb equal to a frequency difference caused by the change in the optical frequency. When a frequency sweep width is Av and the time required for modulation by Av is T, the time difference Δt is expressed by the following expression (1).” “Since a distance Li to an object 113 is ½ of the distance over which light travels during the time difference Δt, the distance Li can be calculated as shown in the following formula (2) using a light speed c in the atmosphere.”

### CITATION LIST

### Patent Literature

PTL 1: JP2021-025952A

### SUMMARY OF INVENTION

### Technical Problem

In the technique disclosed in PTL 1, the distance to a measurement object can be measured in a non-contact manner, but there is a problem that it is difficult to detect an abnormality in a distance measurement value that occurs, for example, when noise is superimposed on a frequency sweep signal supplied to the light source or when the light source is damaged and the frequency sweep width of the measurement light changes, and it is difficult to specify the cause (superimposition of noise on the frequency sweep signal, damage of the light source, or the like) of the abnormality from the change in the distance measurement value.

In handling with this problem, for example, it is also possible to evaluate fluctuation of the frequency sweep width of the measurement light by branching the measurement light and inputting the measurement light to an optical spectrum analyzer, but in this case, a new problem that a device scale increases occurs. There is also a problem that it is difficult to directly observe characteristics of the frequency change during the frequency sweep.

The invention has been made in view of the above points, and an object thereof is to provide a distance measurement system capable of easily evaluating whether a frequency sweep state of a light source is normal while performing non-contact measurement of a distance to a measurement object.

### Solution to Problem

In order to solve the above problem, a distance measurement system according to an aspect of the invention is a distance measurement system that measures a distance to a measurement object in a non-contact manner, the distance measurement system including: a light source configured to output FM light whose optical frequency is periodically swept; a beam splitter configured to split the FM light into two beams; a measurement optical system configured to further split one beam of the two beams, which are obtained by the beam splitter splitting the FM light, into two beams, and output a measurement beat signal based on a frequency difference between one beam of FM light and reflected light occurring when the measurement object is irradiated with the other beam of FM light; a reference optical system configured to further split the other beam of the two beams, which are obtained by the beam splitter splitting the FM light, into two beams, input both beams of FM light obtained by the further splitting to an interferometer having a known optical path length difference, and output a reference beat signal based on a frequency difference between both beams of FM light output by the interferometer; and a calculation device configured to perform calculation processing on the measurement beat signal and the reference beat signal. The calculation device includes a distance measurement unit configured to calculate a distance to the measurement object based on the measurement beat signal, a beat signal processing unit configured to process the reference beat signal to generate a desired signal, and a determination processing unit configured to determine an abnormality of the light source by comparing the desired signal with a reference value.

### Advantageous Effects of Invention

According to the distance measurement system of the invention, it is possible to easily evaluate whether a frequency sweep state of a light source is normal while performing non-contact measurement of a distance to a measurement object. Problems, configurations, and effects other than those described above will be clarified by the following embodiments.

### BRIEF DESCRIPTION OF DRAWINGS

FIG. 1 is a schematic diagram illustrating a configuration example of a distance measurement system according to Embodiment 1.

FIG. 2 is a functional block diagram of a calculation device according to Embodiment 1.

FIG. 3 is an illustrative graph of the distance measurement principle of the FMCW method.

FIG. 4 is an illustrative graph of a method of obtaining a reflection position on a measurement object based on a reflection intensity profile.

FIG. 5 illustrates details of frequency processing and phase analysis processing for a reference beat signal in Embodiment 1.

FIG. 6A is an illustrative graph of evaluation processing of the reference beat signal according to Embodiment 1 (normal state).

FIG. 6B is an illustrative graph of the evaluation processing of the reference beat signal according to Embodiment 1 (abnormal state).

FIG. 7 is a flowchart of the evaluation processing of the reference beat signal according to Embodiment 1.

FIG. 8 illustrates an example of a GUI screen displayed on a display device when an abnormality is determined according to Embodiment 1.

FIG. 9 is a flowchart of evaluation processing of a reference beat signal according to

### Embodiment 2

FIG. 10 is an illustrative graph of evaluation processing of a reference beat signal according to Embodiment 3.

FIG. 11A is an illustrative graph of evaluation processing of a reference beat signal according to Embodiment 4.

FIG. 11B is an illustrative graph of the evaluation processing of the reference beat signal according to Embodiment 4.

FIG. 11C is an illustrative graph of the evaluation processing of the reference beat signal according to Embodiment 4.

### DESCRIPTION OF EMBODIMENTS

Hereinafter, embodiments of a distance measurement system according to the invention will be described with reference to the drawings. In the following embodiments, the same members are denoted by the same reference signs in principle, and a repeated description thereof will be omitted. In each embodiment, it is needless to mention that components (also including element steps and the like) thereof are not necessarily essential unless otherwise specified or unless clearly considered to be essential in principle. Regarding the expressions of “configured with A”, “formed by A”, “having A”, and “including A”, it is needless to say that other elements are not excluded, except for a case where it is clearly indicated that only the element is included. Similarly, in each embodiment, when a shape, a positional relationship, or the like of a component or the like is referred to, the shape or the like is substantially approximate or similar to the shape or the like unless otherwise specified or clearly considered otherwise in principle.

Here, each embodiment is an example for describing the invention, and is omitted and simplified as appropriate for clarity of description. The invention can be implemented in various other forms. Unless otherwise specified, each component may be single or plural.

In order to facilitate understanding of the invention, the position, size, shape, range, and the like of each component shown in the drawings may not represent the actual position, size, shape, range, or the like. Therefore, the invention is not necessarily limited to the positions, sizes, shapes, ranges, or the like disclosed in the drawings.

As examples of various types of information, expressions such as “table”, “list”, and “queue” may be used for description, and the various types of information may be expressed in other data structures.

When there is a plurality of components having the same or similar functions, the plurality of components may be denoted by the same reference signs added with different subscripts. When it is not necessary to distinguish the plurality of components, the description may be made by omitting the subscripts.

In each embodiment, processing performed by executing a program may be described. Here, a computer executes the program by a processor (for example, a CPU or a GPU) and performs processing defined by the program using a storage resource (for example, a memory), an interface device (for example, a communication port), and the like. Therefore, a subject of the processing performed by executing the program may be the processor. Similarly, the subject of the processing performed by executing the program may be a controller, a device, a system, a computer, or a node including a processor. The subject of the processing performed by executing the program may be a calculation unit and may include a dedicated circuit that performs specific processing. Here, the dedicated circuit is, for example, a field programmable gate array (FPGA), an application specific integrated circuit (ASIC), and a complex programmable logic device (CPLD).

The program may be installed on the computer from a program source. The program source may be, for example, a program distribution server or a computer-readable storage medium. When the program source is the program distribution server, the program distribution server may include a processor and a storage resource for storing a program to be distributed, and the processor of the program distribution server may distribute the program to be distributed to another computer. In the embodiment, two or more programs may be implemented as one program, or one program may be implemented as two or more programs.

### Embodiment 1

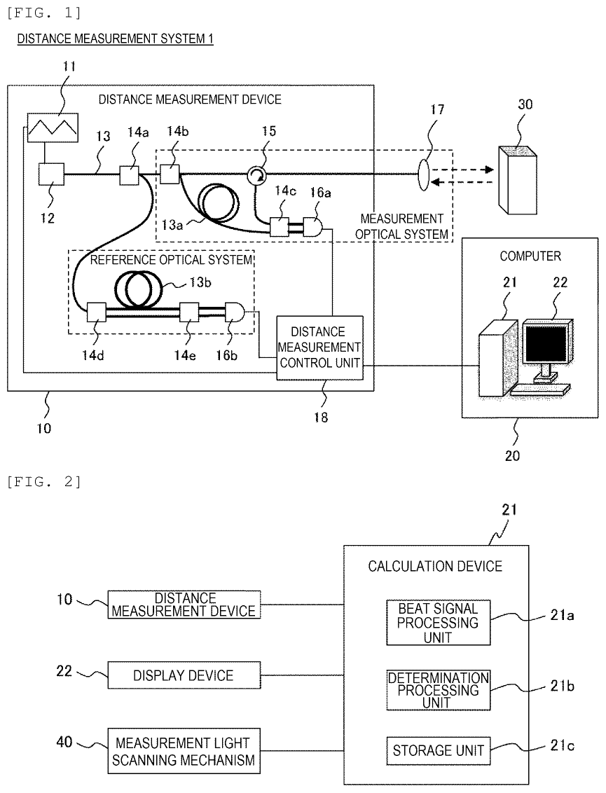

Hereinafter, a distance measurement system 1 according to Embodiment 1 of the invention will be described with reference to FIGS. 1 to 8.

FIG. 1 is a schematic diagram illustrating a configuration example of the distance measurement system 1 according to Embodiment 1. The distance measurement system 1 of the embodiment shown here is a system that measures a distance L to a measurement object 30 in a non-contact manner using a distance measurement device 10 and a computer 20. Although not illustrated in FIG. 1, the distance measurement system 1 may include a measurement light scanning mechanism 40.

The measurement light scanning mechanism 40 is a mechanism that performs scanning at an irradiation position with measurement light emitted by the distance measurement device 10, and a mechanism such as a galvanometer mirror, a MEMS mirror, a polygon mirror, a linear motion stage, or a rotational stage can be used. For example, when one galvanometer mirror is used, the scanning can be performed one-dimensionally at the irradiation position with the measurement light, and when two galvanometer mirrors are used, the scanning can be performed bidirectionally at the irradiation position with the measurement light. Therefore, when the measurement light scanning mechanism 40 is mounted on the distance measurement system 1, a surface of the measurement object 30 can be scanned appropriately at the irradiation position with the measurement light, and a surface shape of the measurement object 30 can be continuously and accurately measured.

### <Distance Measurement Device 10>

As illustrated in FIG. 1, the distance measurement device 10 of the embodiment includes an oscillation part 11, a light emitting part 12, an optical fiber 13, an optical fiber coupler 14, an optical circulator 15, a light receiving part 16, a lens 17, and a distance measurement control unit 18. Hereinafter, the configurations will be sequentially described.

The oscillation part 11 receives a periodically modulated current such as a sawtooth wave, a triangular wave current, or a sine wave based on a command (sweep waveform signal) from the distance measurement control unit 18, and modulates a drive current to be supplied to the light emitting part 12. The waveform of the modulated current is not limited to the above, and may be, for example, a modulated current generated so that optical frequency sweep to be output is substantially linear after characteristics of a current value to be input to the light emitting part 12 and an optical frequency to be output are grasped.

The light emitting part 12 generates frequency modulated (FM) light that is frequency-swept temporally at a constant modulation speed by the drive current modulated by the oscillation part 11, and outputs the frequency modulated light to an optical fiber coupler 14a via the optical fiber 13. The light emitting part 12 may be implemented as a semiconductor laser device having an external resonator, and a resonance wavelength of the light emitting part 12 may be changed by a control signal from the oscillation part 11. Also in this case, the light emitting part 12 can generate FM light whose frequency is temporally swept.

The optical fiber coupler 14a is a beam splitter that splits the incident FM light into two beams, and emits one beam of the FM light to a measurement optical system (14b, 13a, 15, 14c, 16a, 17) and the other beam of the FM light to a reference optical system (14d, 13b, 14e, 16b). As is apparent from this configuration, in the distance measurement system 1 of the embodiment, processing based on an output of the measurement optical system and processing based on an output of the reference optical system can be performed in parallel.

The light incident on the reference optical system is further split into two beams by the optical fiber coupler 14d, multiplexed by the optical fiber coupler 14e, and received by the light receiving part 16b. A relatively long optical fiber 13b is used for one of two optical fibers 13 connecting the optical fiber coupler 14d and the optical fiber coupler 14e, and a predetermined optical path difference is provided with respect to the other. Therefore, the reference optical system functions as a Mach-Zehnder interferometer having a known optical path length difference, and the light receiving part 16b detects a constant beat signal (hereinafter, referred to as a reference beat signal) proportional to the optical path difference. The reference beat signal detected by the reference optical system is transmitted to the distance measurement control unit 18 and the computer 20.

Further, the light incident on the measurement optical system is further split into two beams by the optical fiber coupler 14b, one of which is emitted to the optical fiber 13a as reference light, and the other of which is emitted to the lens 17 through the optical circulator 15 and irradiated to the measurement object 30. Then, light reflected or scattered by the measurement object 30 (hereinafter, referred to as measurement light) is guided to the optical fiber coupler 14c via the lens 17 and the optical circulator 15. The measurement light is multiplexed with the reference light, which passes through the optical fiber 13a, by the optical fiber coupler 14c, and is received by the light receiving part 16a. The light receiving part 16a detects a beat signal (hereinafter, referred to as a measurement beat signal) generated by interference between the reference light and the measurement light. The measurement beat signal detected by the measurement optical system is transmitted to the distance measurement control unit 18 and the computer 20. The configuration of the measurement optical system is not limited to the above. For example, instead of using the optical fiber coupler 14b, the optical fiber 13a, and the optical fiber coupler 14c as parts that split the light incident on the measurement optical system into two beams and generate a measurement beat signal, a partial reflection surface may be provided between an optical path going from the optical circulator 15 to the measurement object 30, and a measurement beat signal may be generated by interference between reflected light (hereinafter, referred to as partially reflected light) from the partial reflection surface and measurement light (that is, the measurement beat signal may be generated by splitting light into two beams on the same optical axis as in a Fizeau interferometer). Fresnel reflected light generated on an end face of the optical fiber between the optical circulator 15 and the lens 17 or a surface of the lens 17 may be used as the partially reflected light. Depending on the configuration of the optical systems, the light receiving part 16a and the light receiving part 16b may use a balanced photodetector including two light receiving elements or a photodetector including one light receiving element.

### <Computer 20>

The computer 20 of the embodiment includes a calculation device 21 that processes the measurement beat signal and the reference beat signal transmitted from the distance measurement device 10, and a display device 22 (for example, a liquid crystal display) that displays a calculation result of the calculation device 21.

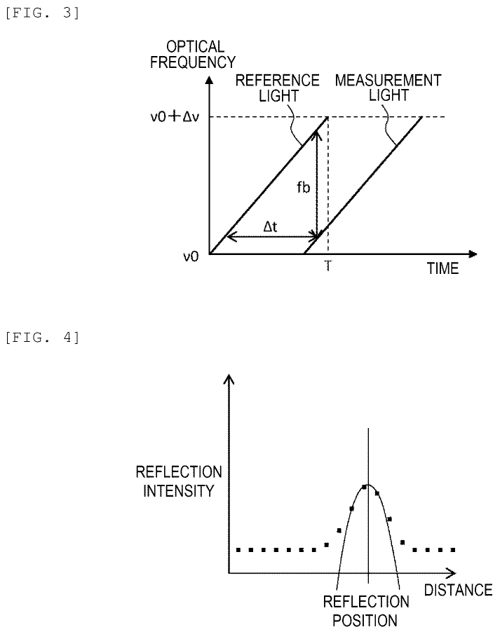

FIG. 2 is a functional block diagram of the calculation device 21. As illustrated here, the calculation device 21 includes functional units such as a beat signal processing unit 21a, a determination processing unit 21b, and a storage unit 21c, and is communicably connected to the distance measurement device 10, the display device 22, the measurement light scanning mechanism 40, and the like. FIG. 2 illustrates a configuration in which functional units such as the beat signal processing unit 21a are mounted on the calculation device 21, and these functional units may be mounted on the distance measurement control unit 18 of the distance measurement device 10. Conversely, the function of the distance measurement control unit 18 of the embodiment may be implemented by the calculation device 21.

Specifically, the calculation device 21 is a computer including hardware such as a calculation device like a CPU, a storage device like a semiconductor memory, and a communication device. The functional units such as the beat signal processing unit 21a are implemented by the calculation device executing a predetermined program, and in the following description, such a well-known technique will be appropriately omitted.

### <Distance Measurement Method Based on Measurement Beat Signal>

In the distance measurement system 1 of the embodiment, frequency modulated continuous waves (FMCW) or swept-source optical coherence tomography (SS-OCT) (or wavelength-swept OCT) is used as a distance measurement method of the distance L to the measurement object 30. Although principles of the FMCW and the SS-OCT are common, the FMCW is a distance measurement method mainly used for long distance measurement using a light source having a long coherence distance, and the SS-OCT is a distance measurement method mainly used for microstructure measurement using a light source having a short coherence distance.

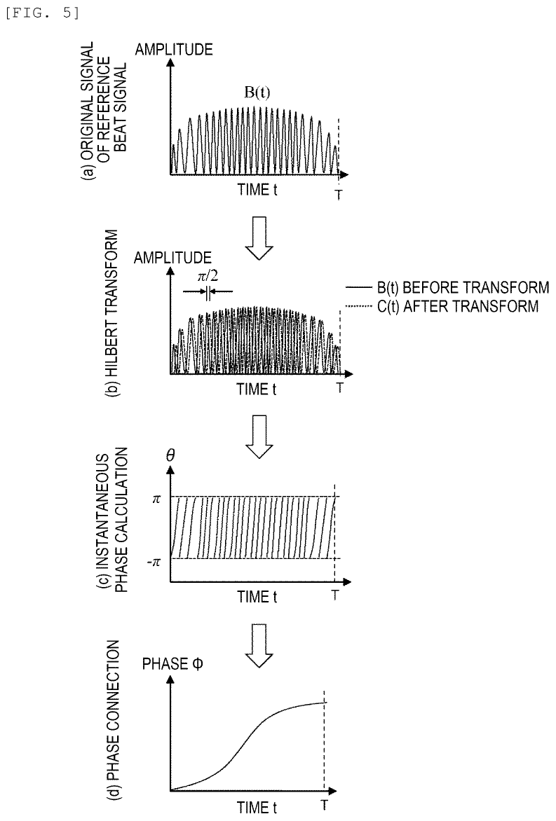

FIG. 3 is an illustrative graph of the distance measurement principle of the FMCW method. Regarding arrival timings of measurement light and reference light to the light receiving part 16a in the measurement optical system, there is a time difference Δt due to an optical path difference between the measurement light and the reference light. In the light emitting part 12 of the embodiment, since the optical frequency changes during the period of the time difference Δt, the light receiving part 16a detects a measurement beat signal having a beat frequency fb equal to a frequency difference between the measurement light and the reference light. For example, when modulation by the oscillation part 11 is frequency modulation of a sawtooth wave, the relationship of the following (Formula 1) is established, in which ν0 is a lowest frequency of emitted light of the light emitting part 12, Δν is a frequency sweep width, and T is the time required for the modulation by Δν.

$$\begin{matrix}[ Math . 1 ] & \\ Δ t = \frac{T}{Δ v} {f}_{b} & ( Formula 1 )\end{matrix}$$

The distance L to the measurement object 30 is half the distance over which light travels during the time difference Δt calculated by Formula 1. Therefore, the distance L can be calculated by the following Formula 2 using a light speed c in the atmosphere.

$$\begin{matrix}[ Math . 2 ] & \\ L = \frac{c Δ t}{2} = \frac{c T}{2 Δ v} {f}_{b} & ( Formula 2 )\end{matrix}$$

The distance L and the beat frequency fb have a linear relationship. Therefore, when first Fourier transform (FFT) is performed on a measurement signal obtained by the light receiving part 16a and a peak position and a magnitude are obtained, a reflection position and a reflected light amount of the measurement object 30 can be obtained.

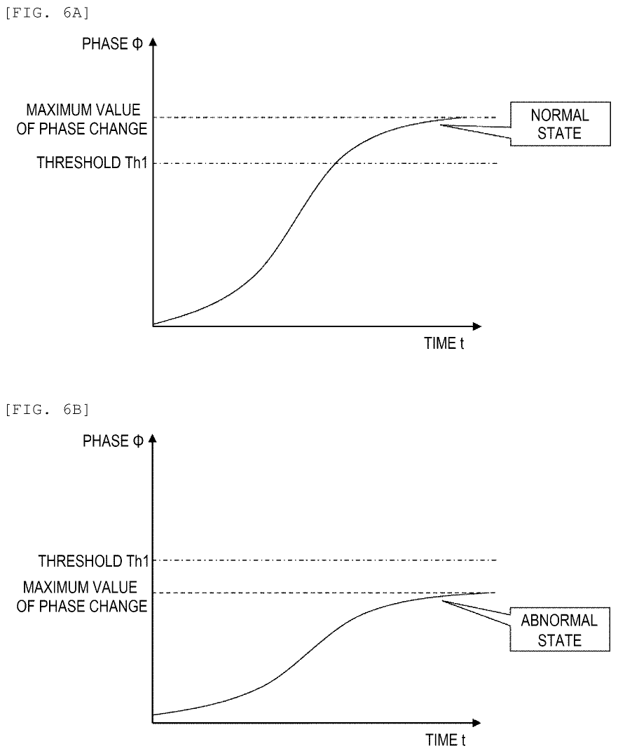

FIG. 4 is a graph illustrating an example of a method of obtaining a reflection position on the surface of the measurement object 30 from a reflection intensity profile. In the drawing, a horizontal axis represents a frequency of FFT, and a vertical axis represents a reflection intensity. As illustrated in the drawing, the vicinity of a peak of the reflection intensity presents discrete data. An interval between the points, that is, the distance resolution is c/2Δv.

When the distance measurement method is the SS-OCT, since a general wavelength is, for example, 1300 nm, a sweep width is 100 nm, and the frequency sweep width Av is 17.8 THz, the distance resolution c/2Δv is 8.4 μm. When the distance measurement method is the FMCW, since a general wavelength is, for example, 1500 nm, a sweep width is 2 nm, and the frequency sweep width Av is 267 GHZ, the distance resolution c/2Δv is 0.56 mm.

On the other hand, as illustrated in FIG. 4, when a function such as a quadratic function or a Gaussian function is applied using three or more points near the peak and interpolation is performed using a value near the peak of the applied function, the resolution can be increased by about 1/10.

Although the FFT is described as an example of the analysis of the beat frequency, for example, the maximum entropy method may be used for the analysis of the beat frequency. In this case, the peak position can be detected with higher resolution than the FFT.

### <Outline of Evaluation Processing Based on Reference Beat Signal>

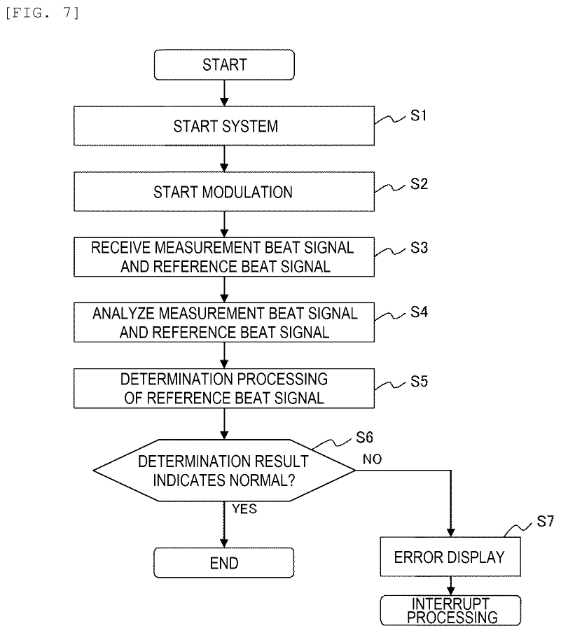

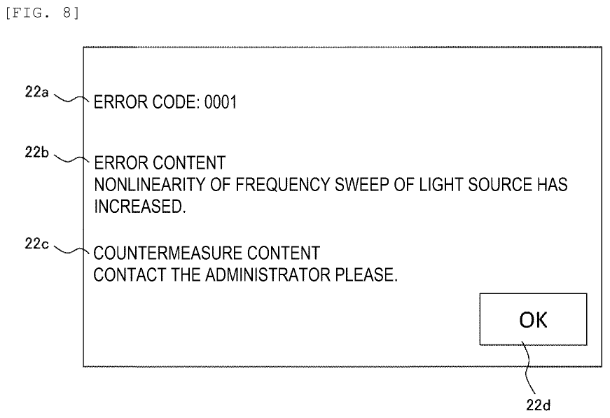

Next, an outline of an evaluation processing based on the reference beat signal detected by the light receiving part 16b of the reference optical system will be described with reference to FIGS. 5, 6A, and 6B. In the following description, the evaluation processing of the reference beat signal is performed by the calculation device 21 (see FIG. 2) of the computer 20. Alternatively, the same evaluation processing may be performed by the distance measurement control unit 18 of the distance measurement device 10 and an evaluation result thereof may be output to the computer 20, or the same evaluation processing may be performed by the distance measurement control unit 18 and the calculation device 21 in cooperation with each other.

First, the beat signal processing unit 21a of the calculation device 21 performs Hilbert transform on an original signal (B(t) in (a) FIG. 5) of the reference beat signal obtained during a measurement cycle to generate a signal (C(t) in (b) of FIG. 5) having a phase shifted by n/2.

Next, the beat signal processing unit 21a calculates an instantaneous phase θ(t) of the signal from the reference beat signal B(t) before the Hilbert transform and the reference beat signal C(t) after the Hilbert transform based on Formula 3 ((c) of FIG. 5).

$$\begin{matrix}[ Math . 3 ] & \\ θ ( t ) = {tan}^{- 1} \frac{C ( t )}{B ( t )} & ( Formula 3 )\end{matrix}$$

Further, the beat signal processing unit 21a sequentially connects the calculated instantaneous phases to obtain a temporal change in phase φ (t) of the reference beat signal during the measurement cycle ((d) of FIG. 5).

Thereafter, the determination processing unit 21b of the calculation device 21 evaluates quality of the reference beat signal based on the change in the phase φ (t) after the phase connection. Specifically, a maximum value of the phase φ(t) obtained during the measurement cycle is compared with a threshold Th1 registered in the storage unit 21c.

The threshold Th1 is a variable depending on characteristics of the reference optical system, and an appropriate value corresponding to the specification of the distance measurement device 10 is registered in advance in the storage unit 21c. The same applies to various thresholds described later.

As illustrated in FIG. 6A, when the maximum value of the phase change is greater than the threshold Th1, the determination processing unit 21b determines that the reference beat signal is normal. Accordingly, the determination processing unit 21b can determine that the distance L calculated based on the measurement beat signal of the same measurement cycle is also normal.

On the other hand, as illustrated in FIG. 6B, when the maximum value of the phase change is equal to or less than the threshold Th1, the determination processing unit 21b determines that the reference beat signal is abnormal. In this case, the determination processing unit 21b determines that reliability of the distance L calculated based on the measurement beat signal of the same measurement cycle is low.

For example, when a frequency sweep signal of the oscillation part 11 is inappropriate and the frequency sweep width decreases, or when the light emitting part 12 fails, the frequency of the reference beat signal is lower than expected, and the maximum value of the phase change decreases. Therefore, as illustrated in FIG. 6B, by comparing the maximum value of the phase change of the reference beat signal with the threshold Th1, an abnormal state of the oscillation part 11 or the light emitting part 12 can be evaluated.

In addition to the above-described evaluation processing, a table of phase changes acquired in advance when the device is in a normal state is held and a value of a difference between phase changes obtained by processing a reference beat signal with respect to the held table is compared with a threshold, and the same effects can be obtained. In this case, it is possible to evaluate a change and jitter in frequency sweep characteristics during the frequency sweep.

### <Details of Evaluation Processing Based on Reference Beat Signal>

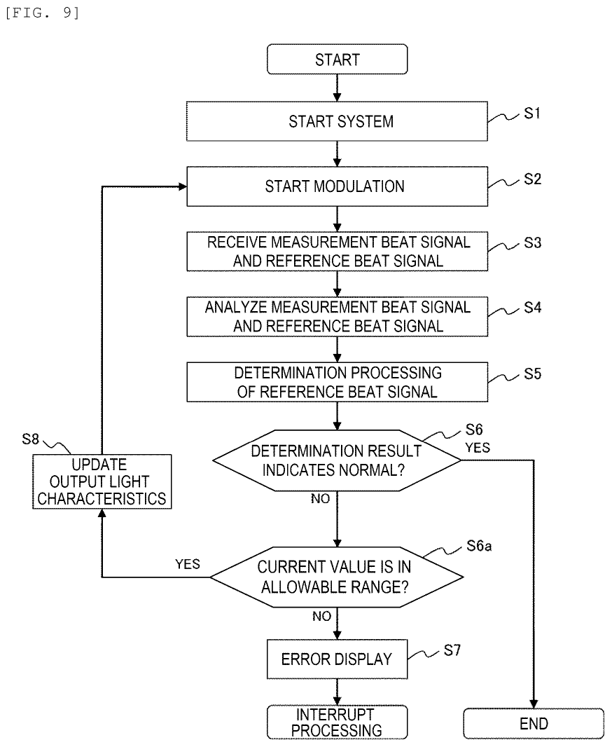

Next, the evaluation processing of the reference beat signal will be described more specifically with reference to a flowchart in FIG. 7. As described above, in the distance measurement system 1 of the embodiment, since the processing based on the output of the measurement optical system and the processing based on the output of the reference optical system can be performed in parallel, FIG. 7 illustrates a situation in which both types of processing are performed in parallel, but when specialized in the evaluation processing, only the output of the reference optical system may be processed.

The processing in FIG. 7 is started in response to a predetermined operation input from a user to the computer 20. Examples of the predetermined operation input include a startup operation of a control program associated with startup of the computer 20 and a measurement start operation of the measurement object 30.

First, in step S1, the distance measurement device 10, the computer 20, and the like constituting the distance measurement system 1 are started. Specifically, the distance measurement control unit 18 of the distance measurement device 10 is set to a standby state in which signals can be transmitted and received, and the calculation device 21 of the computer 20 is also set to a standby state in which signals can be transmitted and received.

Next, in step S2, the oscillation part 11 outputs a modulated current based on a command (sweep waveform signal) from the distance measurement control unit 18, and the light emitting part 12 outputs FM light while modulating an optical frequency based on the modulated current from the oscillation part 11. As a result, as described with reference to FIG. 1, the FM light from the light emitting part 12 is incident on both the measurement optical system and the reference optical system.

In step S3, the distance measurement control unit 18 of the distance measurement device 10 receives a measurement beat signal from the light receiving part 16a of the measurement optical system and receives a reference beat signal from the light receiving part 16b of the reference optical system. The distance measurement control unit 18 transmits the received measurement beat signal and reference beat signal to the calculation device 21 of the computer 20.

In step S4, as described with reference to FIGS. 3 and 4, the distance measurement control unit 18 analyzes the measurement beat signal and calculates the distance L to the measurement object 30. Further, as described with reference to FIG. 5, the beat signal processing unit 21a of the calculation device 21 obtains the instantaneous phase θ(t) after performing the Hilbert transform on the reference beat signal, and further obtains the temporal change in phase φ(t) of the reference beat signal by sequentially connecting instantaneous phases.

In step S5, the determination processing unit 21b of the calculation device 21 executes determination processing of the reference beat signal. Specifically, as illustrated in FIGS. 6A and 6B, the determination processing unit 21b compares the threshold Th1 acquired from the storage unit 21c with the magnitude of the reference beat signal.

In step S6, the determination processing unit 21b determines whether the reference beat signal is normal based on a comparison result in step S5. When the requirement is satisfied, the processing in FIG. 7 is ended, and when the requirement is not satisfied, the processing proceeds to step S7.

When the requirement of step S6 is satisfied, that is, when the maximum value of the phase φ (t) of the reference beat signal is greater than the threshold Th1 and the reference beat signal can be determined to be normal, there is no abnormality in the system and the distance L calculated based on the measurement beat signal can also be determined to be normal. Therefore, the measurement processing based on the measurement beat signal may be continued even after the determination processing of the reference beat signal is ended.

On the other hand, in step S7, the display device 22 displays an error to notify the user of a system abnormality. When the requirement of step S6 is not satisfied and the processing proceeds to step S7, that is, when the maximum value of the phase φ (t) of the reference beat signal is equal to or less than the threshold Th1 and the reference beat signal can be determined to be abnormal, the distance L calculated based on the measurement beat signal acquired in the same measurement cycle can also be determined to be abnormal. Therefore, the subsequent measurement processing is interrupted in order to avoid erroneous measurement of the distance L.

### <Error Display Method>

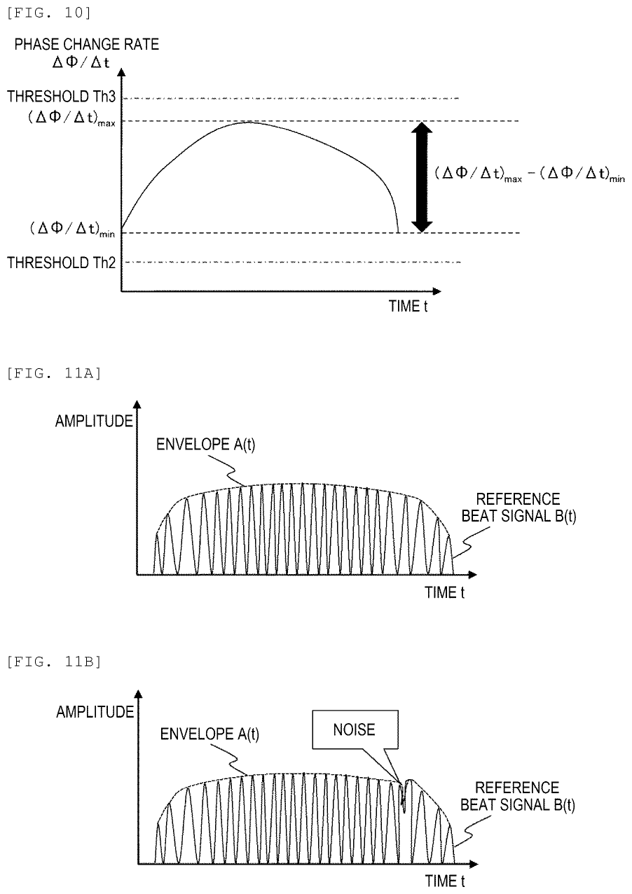

Next, an error display method in step S7 will be described in detail with reference to FIG. 8. FIG. 8 illustrates a display example of a GUI screen displayed on the display device 22 when the reference beat signal is determined to be abnormal in step S6 and the process proceeds to step S7.

On the GUI screen exemplified here, an error code display field 22a, an error content display field 22b, a countermeasure content display field 22c, and a confirmation button 22d are displayed. In the error code display field 22a, a code number assigned according to the evaluation content in step S6 is displayed. The error content display field 22b displays details of the error content corresponding to each code number. The countermeasure content display field 22c displays countermeasure content corresponding to the error content. When the confirmation button 22d is pressed, the display of the GUI screen is interrupted. The error code, the error content, and the countermeasure content displayed here may be those registered in advance in the storage unit 21c.

The display of the GUI screen is not limited to the content illustrated in FIG. 11, and only a part thereof may be displayed. For example, the error content display field 22b may display only the countermeasure content without displaying the details of the error content. When the confirmation button 22d is pressed, the measurement operation may be interrupted and the operation may proceed to an operation of terminating the device, or other associated information such as an occurrence time may be displayed additionally.

Further, as another method of notifying the user of the evaluation result, an alarm lamp or a buzzer may be provided and activated when an abnormal state is determined. A lamp indicating a sound state may be provided on the screen of the distance measurement device 10 or the display device 22, and may be turned on when it is determined that the determination result is normal. Further, a log file for recording a status of the device may be held, and a determination result, an evaluated value, and a date may be recorded together, or may be recorded in a header area when distance measurement data is stored as a file. Further, the calculation device 21 may include an external output terminal to output a signal to an external device at the time of interrupting the processing.

The threshold Th used in the evaluation processing may be changeable by providing a parameter setting screen on a GUI. The value of each threshold may be stored in a threshold setting file, and the threshold setting file may be loaded at the time of program start.

According to the distance measurement system of the embodiment described above, it is possible to easily evaluate whether a frequency sweep state of a light source is normal while performing non-contact measurement of a distance to a measurement object.

### Embodiment 2

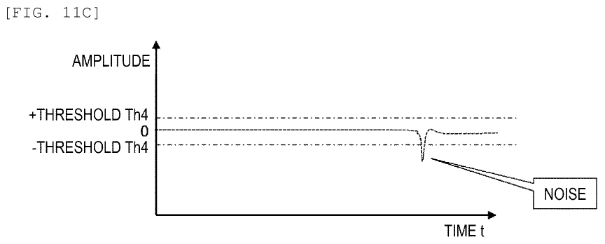

Next, the distance measurement system 1 according to Embodiment 2 of the invention will be described with reference to a flowchart in FIG. 9. A repeated description of points in common with Embodiment 1 will be omitted.

In the flowchart in FIG. 7 of Embodiment 1, when the requirement of step S6 is not satisfied, the processing immediately proceeds to step S7 (error display), but in the flowchart in FIG. 9 of the embodiment, when the requirement of step S6 is not satisfied, the processing proceeds to step S6a, when the requirement of step S6a is satisfied, the system is improved in step S8, and only when the requirement of step S6a is not satisfied, the processing proceeds to step S7 (error display). Hereinafter, the significance of steps S6a and S8 added in the embodiment will be sequentially described.

In step S6a, the distance measurement control unit 18 determines whether a current value of a modulation signal output from the oscillation part 11 is within an allowable range, that is, whether there is room for improving the reference beat signal by changing the current value of the modulation signal. When the requirement is satisfied (there is room for improvement), the processing proceeds to step S8, and when the requirement is not satisfied (there is no room for improvement), the processing proceeds to step S7 (error display) described above. As the error display in the latter case, a message indicating that automatic recovery is impossible may be displayed.

In step S8, the distance measurement control unit 18 updates a command (sweep waveform signal) to be transmitted to the oscillation part 11. More specifically, for example, an amplitude or a direct current (DC) component of a waveform of the modulation signal output from the oscillation part 11 is updated by being increased by a certain amount, thereby increasing an optical frequency modulation width or an optical frequency of output light and attempting to increase a maximum phase value of the reference beat signal.

With the above steps S6a and S8, a processing path for restarting the modulation with an updated modulation signal (step S2) and reevaluating the reference beat signal (steps S5 and S6) even when the reference beat signal is determined to be abnormal in step S6 is added. Therefore, according to the distance measurement system of the embodiment, a normal measurement beat signal can be detected by changing the system control to improve the reference beat signal that is determined to be abnormal.

### Embodiment 3

Next, the distance measurement system 1 according to Embodiment 3 of the invention will be described with reference to FIG. 10. A repeated description of points in common with the above embodiments will be omitted.

In steps S5 and S6 of Embodiment 1, the quality of the reference beat signal is determined based on the phase ¢ of the reference beat signal, but in steps S5 and S6 of the embodiment, the quality of the reference beat signal is determined by obtaining a time change rate (hereinafter, referred to as a phase change rate) of the phase φ of the reference beat signal and comparing the time change rate with a predetermined threshold. Instead of obtaining the phase change rate per hour, the phase change rate according to a sampling rate in taking in the reference beat signal may be obtained.

Specifically, with the beat signal processing unit 21a and the determination processing unit 21b of the calculation device 21 of the embodiment, a maximum value (Δφ/Δt)ₘₐₓ of the phase change rate of the reference beat signal and a minimum value (Δφ/Δt)ₘᵢₙ of the phase change rate are obtained, a width of the phase change rate obtained by (Δφ/Δt)ₘₐₓ−(Δφ/Δt)ₘᵢₙ is compared with a predetermined threshold Th, and an abnormality is determined when the width of the phase change rate is equal to or greater than the threshold Th.

Alternatively, the beat signal processing unit 21a and the determination processing unit 21b may analyze the frequency of the reference beat signal by FFT, compare a spread width (for example, a full width at half maximum) of a frequency spectrum with the threshold Th, and determine an abnormality when the spread width is equal to or greater than the threshold Th. Accordingly, the same effects are obtained.

Since a magnitude difference of the value of the phase change rate increases when nonlinearity of the frequency modulation is high, it is possible to evaluate nonlinearity of frequency sweep characteristics and deterioration of frequency analysis accuracy of the measurement beat signal by the evaluation of the embodiment.

Further, as illustrated in FIG. 10, the determination processing unit 21b may compare the minimum value (Δ/Δt)ₘᵢₙ of the phase change rate with a threshold Th2 and determine an abnormality when the minimum value (Δφ/Δt)ₘᵢₙ of the phase change rate is less than the threshold Th2, or may compare the maximum value (Δφ/Δt)ₘₐₓ of the phase change rate with a threshold Th3 and determine an abnormality when the maximum value (Δφ/Δt)ₘₐₓ of the phase change rate is greater than the threshold Th3.

In a case of executing resampling processing to be described later, if a beat signal having an excessively small phase change rate or an excessively large phase change rate is included in a measurement cycle, a density of interpolation points generated at the time of the resampling processing varies, and thus the throughput of the resampling processing or the measurement accuracy may decrease. In order to avoid this, the minimum value (Δφ/Δt)ₘᵢₙ of the phase change rate or the maximum value (Δφ/Δt)ₘₐₓ of the phase change rate is compared with the threshold, so that it is possible to evaluate whether the resampling processing can be normally executed.

In addition to the above-described evaluation processing, a phase change rate table φ′ (t) acquired in advance when the device is in a normal state may be held, and a difference φ (t)-φ′ (t) between phase change rates obtained by processing a reference beat signal with respect to the held table may be compared with a threshold. In this case, it is possible to evaluate a change in frequency sweep characteristics and jitter during the frequency sweep.

### <Resampling Processing by Distance Measurement Control Unit 18>

Here, a method of performing resampling processing on a measurement beat signal obtained by the light receiving part 16a of the measurement optical system using a reference beat signal obtained by the light receiving part 16b of the reference optical system will be described.

The distance measurement control unit 18 samples the reference beat signal and the measurement beat signal with a sampling clock at regular time intervals. By performing Hilbert transform on the reference beat signal and obtaining a phase change of the reference beat signal, a timing at which the reference beat signal has a constant phase can be obtained. In accordance with this timing, the measurement beat signal is resampled. That is, based on the phase change of the reference beat signal, the measurement beat signal is resampled at regular intervals of the phase change. Even when the measurement beat signal is sampled and subjected to A/D conversion by an AD/DA converter, which is built in the distance measurement control unit 18, using the reference beat signal as a sampling clock, the same effects are obtained. FFT is performed on the measurement beat signal after the resampling processing, and the beat frequency is estimated to obtain the distance L to the measurement object 30.

By resampling the measurement beat signal using the reference beat signal as described above, the measurement beat signal of which the nonlinearity of the frequency sweep is restricted can be obtained, so that the accuracy of frequency estimation can be improved. In addition, the resampling processing and the evaluation of the reference beat signal use the same hardware structure and use the result of the Hilbert transform of the reference beat signal, and thus can be implemented at the same time.

### Embodiment 4

Next, the distance measurement system 1 according to Embodiment 4 of the invention will be described with reference to FIGS. 11A to 11C. A repeated description of points in common with the above embodiments will be omitted.

In steps S5 and S6 of Embodiment 1, the quality of the reference beat signal is determined based on the phase φ of the reference beat signal, but in steps S5 and S6 of the embodiment, an envelope A(t) of the reference beat signal is obtained, and the quality of the reference beat signal is determined based on the envelope A(t).

Therefore, in the beat signal processing unit 21a of the embodiment, first, an original signal (B(t) in FIG. 4A) of the reference beat signal obtained during a measurement cycle is subjected to Hilbert transform to generate a signal (C(t) in FIG. 4B) having a phase shifted by n/2.

Next, the beat signal processing unit 21a obtains the envelope A(t) of the reference beat signal from the reference beat signal B(t) before the Hilbert transform and the reference beat signal C(t) after the Hilbert transform based on the following Formula 4. Accordingly, an envelope A(t) as shown in FIGS. 11A and 11B can be obtained. In FIGS. 11A and 11B, illustration of the reference beat signal C(t) after the Hilbert transform is omitted for simplification.

$$\begin{matrix}[ Math . 4 ] & \\ A ( t ) = \sqrt{{C ( t )}^{2} + {B ( t )}^{2}} & ( Formula 4 )\end{matrix}$$

Thereafter, the determination processing unit 21b performs high pass filter processing on the obtained envelope A(t) and compares the envelope A(t) with a threshold Th4 (FIG. 11C).

Here, as illustrated in FIG. 11A, when noise is not superimposed on the reference beat signal B(t), the envelope A(t) can be obtained as a substantially smooth curve. Therefore, the curve after the high pass filter processing does not exceed the threshold Th4 described later.

On the other hand, when noise is superimposed on the reference beat signal B(t) as illustrated in FIG. 11B, a sharp change occurs in the curve of the envelope A(t) after the high pass filter processing at a position where the noise is superimposed, and an absolute value of the change exceeds the threshold Th4, as illustrated in FIG. 11C. Therefore, the determination processing unit 21b of the embodiment can evaluate, for example, noise of a control current of the light emitting part 12 and the noise of the frequency sweep signal generated in the oscillation part 11, based on observation of the reference beat signal.

Instead of the high pass filter processing, an envelope table A′ (t) obtained in advance in a normal state may be held and a calculation result of A(t)-A′ (t) (that is, a difference of an envelope waveform from the normal state) may be compared with the threshold Th4. Accordingly, the same effects are obtained with the evaluation. In this case, it is possible to evaluate a change in modulation characteristics of an output intensity during the frequency sweep.

In addition, the determination processing unit 21b of the embodiment may compare a maximum value A(t)ₘₐₓ of the envelope with a threshold Th5 and determine an abnormality when the maximum value A(t)ₘₐₓ of the envelope is less than the threshold Th5. According to the evaluation processing, it is possible to detect a decrease in light intensity output from the light emitting part 12.

Further, the determination processing unit 21b of the embodiment may compare the maximum value A(t)ₘₐₓ of the envelope with a threshold Th6 and determine an abnormality when the maximum value A(t)ₘₐₓ of the envelope is equal to or greater than the threshold Th6. According to the evaluation processing, for example, it is possible to evaluate whether a signal obtained by a detector 16a or a detector 16b is saturated with an excessive light intensity.

In step S6 of the embodiment, when the maximum value A(t)ₘₐₓ of the envelope of the reference beat signal is compared with the threshold Th6 and an abnormality is determined since the maximum value A(t)ₘₐₓ of the envelope is equal to or greater than the threshold Th6, in step S8 of the embodiment, a control current value of an optical amplifier or a control voltage value of an attenuator separately provided in the distance measurement device 10 may be updated by a certain amount in addition to the update of the modulation signal. More specifically, examples of the optical amplifier include an erbium doped fiber amplifier (EDFA), a praseodymium doped fiber amplifier (PDFA), a fiber Raman amplifier (FRA), and a semiconductor optical amplifier (SOA), and a trial of increasing the maximum value of the envelope A(t) by updating the control current value of these optical amplifiers by a certain amount is performed. An appropriate optical amplifier may be selected according to a wavelength band of the light emitting part 12. similar processing is possible as long as an evaluation index can be improved by adjusting a control parameter of the light emitting part 12.

Although the embodiments have been described above, the invention is not limited to the above-described embodiments, and includes various modifications. For example, the above-described embodiments have been described in detail to facilitate understanding of the invention, and the invention is not limited to those including all the configurations described here. A part of the configuration of one embodiment can be replaced with the configuration of another embodiment. A configuration of another embodiment can be added to a configuration of one embodiment. A part of a configuration in each embodiment may also be added to, deleted from, or replaced with another configuration. A part or all of the configurations, functions, processing units, processing methods, and the like described above may be implemented by hardware by, for example, designing with an integrated circuit. Further, control lines and information lines considered to be necessary for the description are shown in the drawings, and not all control lines and information lines are shown. Almost all configurations may be considered to be connected.

The above configuration may be classified into more components according to processing content. Further, one component may be classified so as to execute more processing.

### REFERENCE SIGNS LIST

1 distance measurement system,
10 distance measurement device,
11 oscillation part,
12 light emitting part,
13 optical fiber,
14 optical fiber coupler,
15 optical circulator,
16 light receiving part,
17 lens
18 distance measurement control unit,
20 computer,
21 calculation device,
21a beat signal processing unit,
21b determination processing unit,
21c storage unit,
22 display device,
30 measurement object,
40 measurement light scanning mechanism

1. A distance measurement system that measures a distance to a measurement object in a non-contact manner, the distance measurement system comprising:
a light source configured to output FM light whose optical frequency is periodically swept;
a beam splitter configured to split the FM light into two beams;
a measurement optical system configured to further split one beam of the two beams, which are obtained by the beam splitter splitting the FM light, into two beams, and output a measurement beat signal based on a frequency difference between one beam of FM light and reflected light occurring when the measurement object is irradiated with the other beam of FM light;
a reference optical system configured to further split the other beam of the two beams, which are obtained by the beam splitter splitting the FM light, into two beams, input both beams of FM light obtained by the further splitting to an interferometer having a known optical path length difference, and output a reference beat signal based on a frequency difference between both beams of FM light output by the interferometer; and
a calculation device configured to perform calculation processing on the measurement beat signal and the reference beat signal, wherein
the calculation device includes
a distance measurement unit configured to calculate a distance to the measurement object based on the measurement beat signal,
a beat signal processing unit configured to process the reference beat signal to generate a desired signal, and
a determination processing unit configured to determine an abnormality of the light source by comparing the desired signal with a reference value.

2. The distance measurement system according to claim 1, wherein
the beat signal processing unit generates, as the desired signal, a temporal change in phase of the reference beat signal in which instantaneous phases calculated from the reference beat signal are sequentially connected for a certain period, and
the determination processing unit determines the light source to be abnormal when a maximum value of the temporal change in phase of the reference beat signal is equal to or less than the reference value.

3. The distance measurement system according to claim 1, wherein
the beat signal processing unit generates, as the desired signal, a difference between a maximum value and a minimum value of a change rate of a temporal change in phase of the reference beat signal in which instantaneous phases calculated from the reference beat signal are sequentially connected for a certain period, and
the determination processing unit determines the light source to be abnormal when the difference is equal to or greater than the reference value.

4. The distance measurement system according to claim 1, wherein
the beat signal processing unit generates, as the desired signal, a spread width of a frequency spectrum obtained by performing FFT analysis on a frequency of the reference beat signal, and
the determination processing unit determines the light source to be abnormal when the spread width of the frequency spectrum is equal to or greater than the reference value.

5. The distance measurement system according to claim 1, wherein
the beat signal processing unit generates, as the desired signal, a minimum value of a change rate of a temporal change in phase of the reference beat signal in which instantaneous phases calculated from the reference beat signal are sequentially connected for a certain period, and
the determination processing unit determines the light source to be abnormal when the minimum value is less than the reference value.

6. The distance measurement system according to claim 1, wherein
the beat signal processing unit generates, as the desired signal, a maximum value of a change rate of a temporal change in phase of the reference beat signal in which instantaneous phases calculated from the reference beat signal are sequentially connected for a certain period, and
the determination processing unit determines the light source to be abnormal when the maximum value exceeds the reference value.

7. The distance measurement system according to claim 1, wherein
the beat signal processing unit generates an envelope of the reference beat signal as the desired signal, and
the determination processing unit determines the light source to be abnormal when an absolute value of a high pass filter processing result of the envelope is equal to or greater than the reference value.

8. The distance measurement system according to claim 1, wherein
the beat signal processing unit generates an envelope of the reference beat signal as the desired signal, and
the determination processing unit determines the light source to be abnormal when a maximum value of the envelope is less than the reference value.

9. The distance measurement system according to claim 1, wherein
the beat signal processing unit generates an envelope of the reference beat signal as the desired signal, and
the determination processing unit determines the light source to be abnormal when a maximum value of the envelope is equal to or greater than the reference value.

10. The distance measurement system according to claim 1, further comprising:
a display device, wherein
when an abnormality is determined by the determination processing unit, any one of an error code, error content, and countermeasure content is displayed on the display device.
